(19) United States
(12) Patent Application Publication
(10) Pub. No.: US 2026/0342923 A1
(43) Pub. Date: Oct. 29, 2026

(54) LOCATE TARGET OBJECTS BASED ON FIDUCIAL MARKS

(71) Applicant: Hewlett-Packard Development Company, L.P., Spring, TX (US)

(72) Inventors: Clinton Troy Jensen, Boise, ID (US); Alan Williamson, Boise, ID (US)

(21) Appl. No.: 19/123,488

(22) PCT Filed: Oct. 26, 2022
(86) PCT No.: PCT/US2022/047836

§ 371 Date: Apr. 23, 2025

(51) Int. Cl. H04N 1/00; G06K 7/14; G06T 7/73

(52) U.S. Cl. CPC H04N 1/00334; G06K 7/1417; G06T 7/74; H04N 1/00037; H04N 1/00074; G06T 2207/10008; G06T 2207/30144; G06T 2207/30204; G06T 2207/30242; H04N 2201/0081

(57) ABSTRACT

In some examples, an electronic device can include a processing resource, and a non-transitory memory resource storing machine-readable instructions to cause the processing resource to detect a fiducial mark of a plurality of fiducial marks on a scanned image, where the scanned image includes the plurality of fiducial marks and a plurality of target objects, and each fiducial mark of the plurality of fiducial marks is uniquely associated with a respective target object of the plurality of target objects, locate, based on the fiducial mark, a target object on the scanned image associated with the fiducial mark, and process the target object.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is an example of a scanned image having fiducial marks and target objects consistent with the disclosure.

FIG. 2A is an example of a fiducial mark located proximate with a target object in a non-distorted area consistent with the disclosure.

FIG. 2B is an example of a fiducial mark located proximate with a target object in a distorted area consistent with the disclosure.

FIG. 2C is an example of a fiducial mark located around a target object consistent with the disclosure.

FIG. 3 is an example of a system to locate target objects based on fiducial marks consistent with the disclosure.

FIG. 4 is an example of an electronic device to locate target objects based on fiducial marks.

FIG. 5 is a block diagram of an example system to locate target objects based on fiducial marks consistent with the disclosure.

FIG. 6 is an example of a method to locate target objects based on fiducial marks consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images, models, etc.) on the medium during a print job. Print material may include ink, toner, polymers, metals, colorants, etc.

The print material can be deposited onto media, such as a physical medium. As used herein, the term “imaging device” refers to any hardware device with functionalities to physically produce representation(s) (e.g., text, images, models, etc.) on the medium. In some examples, “media” may include paper, photopolymers, plastics, composite, metal, wood, fabric, or the like. An imaging device can further include other functionalities such as scanning, faxing, and/or other imaging device functionalities, and can perform print jobs when in receipt of a print job request from a computing device or other network (e.g., Internet) connected device and/or scan jobs when in receipt of a scan job request.

In some examples, a print job may derive from media being processed by an electronic device. As used herein, the term “electronic device” refers to an electronic system having a processing resource, memory resource, and/or an application-specific integrated circuit (ASIC) that can process information. Examples of electronic devices can include, for instance, a scanning device, a laptop computer, a notebook computer, a desktop computer, an All-In-One (AIO) computing device, networking equipment (e.g., router, switch, etc.), and/or a mobile device, among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices. For example, an electronic device may process media by scanning the media via a scanning device associated with the electronic device. As used herein, the term “scanning device” refers to a device that optically scans a media and converts it to a digital image. For example, a scanning device may scan an image on media and convert the image to a digital image. The scanning device may be or include an automatic document feeder (ADF).

In some instances, printing (e.g., during a print job) can introduce print defects that can result in a distorted area on a print medium. As used herein, the term “print defect” refers to an imperfection on a print medium introduced during a print job. As used herein, the term “distorted area” refers to a space having an imperfection. Printing defects can include, for example, skew, translation, creasing, stretch, compression, etc. In certain print jobs (e.g., such as long paper formats), a higher chance of introducing such print defects can exist relative to short paper formats when certain imaging devices are utilized for long paper formats when they were not specifically designed for long paper formats. In an instance in which a medium having a print defect is scanned, the print defect may be included in the resulting scanned digital image as is further described herein.

Additionally, in some instances a print job may produce a medium without print defects. However, when the medium is scanned, scanned image defects may be introduced in the resulting digital image. As used herein, the term “scanned image defect” refers to an imperfection on a digital image introduced during a scan job. Scanned image defects can be similar to print defects, and can include defects such as skew, translation, creasing, stretch, compression, etc. In some examples, such scanned image defects may additionally be the result of scanning long paper formats when the imaging device is not designed specifically for scanning long paper formats. Accordingly, the scanned image defect may be included in the resulting scanned digital image.

Further, in some examples, defects may be introduced in both the print job and the scan job. Such digital images having defects introduced during both the print job process and the scan process may include compounded image defects in the resulting scanned digital image resulting in printed and/or scanned digital images that vary greatly from the original design intent.

As a result of the various image defects that may occur, analysis of the scanned digital image may be affected. For example, if the image includes various target objects intended for analysis, it may be difficult to locate the various target objects as they may not appear in an area in which the electronic device analyzing them expects them to be (e.g., as a result of the image defect). For example, the electronic device may expect a target object to appear in a first position but is now located in a second position because of skew and/or other defects. As a result, the electronic device may not be able to locate the target object, which may result in incorrect processing.

One approach to addressing such image defects is to utilize a fiducial marker or a set of fiducial markers to define a searchable grid. Utilizing the searchable grid, the electronic device can locate target objects. However, if the image defect is great enough, the target object to be located may fall outside of the expected/predetermined areas of the searchable grid, resulting in the electronic device locating the wrong target object or not locating the target object at all. In such an example, processing of the target objects on the scanned image may not be accurately performed.

Locating target objects based on fiducial marks according to the disclosure can allow for accurate detection of target objects even in instances where an image defect is introduced, either during a print job, a scan job, and/or during handling of the media. A unique set of fiducial marks can each correspond to a particular respective target object, resulting in a 1:1 fiducial mark/target object ratio such that each target object can be located based on location of an associated fiducial mark. Additionally, processing of the target objects can be cross-checked so that every target object is correctly handled, reducing chances of processing errors. Accordingly, such an approach can allow for a more accurate analysis of the digital image as compared with previous approaches.

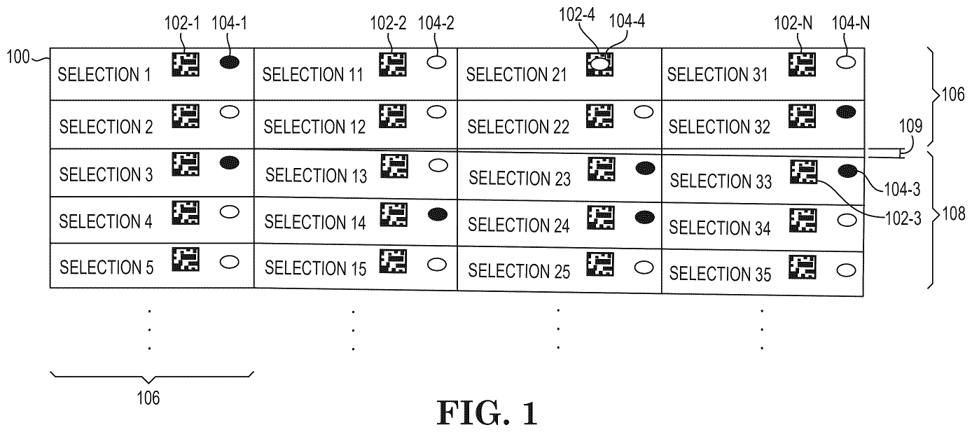

FIG. 1 is an example of a scanned image 100 having fiducial marks 102 and target objects 104 consistent with the disclosure. As illustrated in FIG. 1, the scanned image 100 can include a non-distorted area 106 and a distorted area 108.

As illustrated in FIG. 1, the scanned image 100 can include various fiducial marks 102 and target objects 104. The scanned image 100 can be a scan of a media having various types of information located thereon. In some examples, the scanned image 100 may be a survey sheet (e.g., a sheet to extract data from respondents to the survey via the survey sheet). In some examples, survey sheets may include a ballot (e.g., a sheet used to cast votes for use in an election). In some examples, the scanned image 100 may be an exam having various questions and possible answers. However, examples of the disclosure are not limited to survey sheets and/or exams. For example, the scanned image 100 can be any other type of media for any other purpose.

A user may interact with the print media prior to scanning. For instance, in the example in which the scanned image 100 is a survey sheet, a user may dictate a mark onto the print medium in order to cast a vote for a particular answer. Such a mark may be dictated onto a target object 104 by the user filling in or otherwise marking the target object 104. As used herein, the term “target object” refers to an area defining a submission based on whether a mark is located in the area. For example, if a user leaves a mark in the target object (e.g., via ink, pencil graphite, or otherwise), the mark in the target object indicates a user's submission regarding a particular selection on the print medium. Once a user has completed interactions with the print medium (e.g., filling in various ones of the target objects 104), the print medium may be scanned to generate the scanned image 100.

As illustrated in FIG. 1, the scanned image 100 can include various target objects 104-1, 104-2, 104-3, 104-4, 104-N. Each of the target objects 104 can be associated with a particular selection. For example, “SELECTION 1” can include corresponding target object 104-1, “SELECTION 2” can include corresponding target object 104-2, “SELECTION 3” can include corresponding target object 104-3, “SELECTION 4” can include corresponding target object 104-4, and “SELECTION N” can include corresponding target object 104-N. In an example in which the scanned image 100 is a survey sheet, SELECTION 1 may be a particular answer, and a user inputting a mark onto the print medium for target object 104-1 can indicate the user selecting the particular answer to vote for. When the scanned image 100 is generated (e.g., when the print medium is scanned by an electronic device), the user's mark in the target object 104-1 can be indicated in the scanned image 100 accordingly.

The target objects 104 are illustrated in FIG. 1 as bubbles. However, examples of the disclosure are not so limited. For example, the target objects 104 can be check boxes, circles, and/or any other type and/or shape of target object 104.

The scanned image 100 can further include fiducial marks 102. As used herein, the term “fiducial mark” refers to an object placed in a field of view of an imaging system for use as a point of reference and/or measure. As illustrated in FIG. 1, the scanned image 100 can include fiducial marks 102-1, 102-2, 102-3, 102-N. Each of the fiducial marks 102 can be uniquely associated with a respective target object 104. For example, fiducial mark 102-1 can be uniquely associated with target object 104-1, fiducial mark 102-2 can be uniquely associated with target object 104-2, fiducial mark 102-3 can be uniquely associated with target object 104-3, fiducial mark 102-4 can be uniquely associated with target object 104-4, and fiducial mark 102-N can be uniquely associated with target object 104-N. Additionally, each fiducial mark 102 is unique from the other fiducial marks 102. For example, fiducial mark 102-1 can be different from fiducial mark 102-2 which can be different from fiducial mark 102-3, etc. The fiducial marks 102 and the target objects 104 can include a unique 1:1 ratio where every fiducial mark 102 uniquely corresponds to a respective target object 104. Such a unique 1:1 ratio can allow for each target object 104 to be located upon detection of an associated fiducial mark 102, as is further described herein.

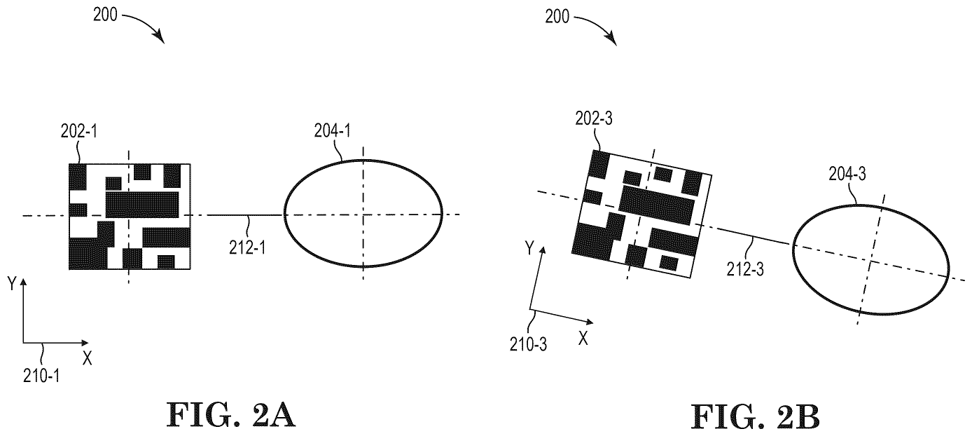

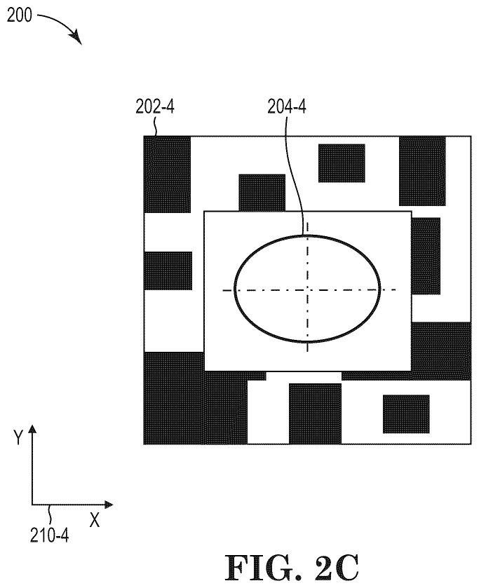

As illustrated in FIG. 1, the fiducial marks 102 located on the scanned image 100 can be quick response (QR) codes. As used herein, the term “QR code” refers to a machine-readable optical label including information about another object. The QR codes acting as fiducial marks 102 can allow for unique information to be stored within each fiducial mark 102. That is, each fiducial mark 102 (e.g., each unique QR code) can define a search instruction to locate a corresponding target object 104. As used herein, the term “search instruction” refers to an order or set of orders that define a location. Such search instructions can be utilized to locate each corresponding target object 104. For example, as mentioned above, since each fiducial mark 102 is uniquely associated with a respective target object 104, each fiducial mark 102 can define a unique search instruction to locate a respective target object 104. That is, fiducial mark 102-1 can define a first search instruction to locate target object 104-1, fiducial mark 102-2 can define a second search instruction to locate target object 104-2, fiducial mark 102-3 can define a third search instruction to locate target object 104-3, fiducial mark 102-4 can define a fourth search instruction to locate target object 104-4, fiducial mark 102-N can define an N'th search instruction to locate target object 104-N, etc. The search instructions can include a coordinate system, a search direction, a search distance, and/or a search area, as is further described in connection with FIGS. 2A-2C.

Although the fiducial marks 102 are described above and illustrated in FIG. 1 as being QR codes, examples of the disclosure are not so limited. For example, the fiducial marks 102 can be bar codes (e.g., two-dimensional (2D) bar codes), markers made with magnetic toner or ultra-violet (UV) toner, etc. Additionally, although illustrated in FIG. 1 as being visible, in some examples, the fiducial marks 102 may not be visible (e.g., to humans), but may be visible to an electronic device (e.g., via UV toner, magnetic toner, etc.).

As illustrated in FIG. 1, in some examples, the fiducial marks 102 can be located proximate to the target objects 104. For example, the fiducial marks 102-1, 102-2, and 102-3 can be located proximate to target objects 104-1, 104-2, and 104-3, respectively. However, examples of the disclosure are not so limited. For instance, in some examples, the fiducial marks 102-can be located around the target object 104. For example, fiducial mark 102-4 can be located around target object 104-4. Such locations of fiducial marks 102 relative to target objects 104 are further described in connection with FIGS. 2A-2C.

The scanned image 100 can include a non-distorted area 106. As used herein, the term “non-distorted area” refers to a location on the scanned image 100 that does not include a print job defect and/or a scanned image defect. For example, the non-distorted area 106 can be free of any skew, translation, creasing, stretch, compression, etc. that may be introduced to the scanned image 100 during printing or scanning.

As mentioned above, in some instances, the scanned image 100 can include a distorted area 108. As used herein, the term “distorted area” refers to a location on the scanned image 100 that does include a print job defect and/or a scanned image defect. The distorted area 108 may include any one of skew, translation, creasing, stretch, compression, etc. that may have been introduced to the scanned image 100 during printing or scanning. As illustrated in FIG. 1, the distorted area 108 can include skew. The skew can be at a particular skew angle 109. For example, the skew angle 109 can be 4 degrees (°) (e.g., relative to the horizontal row line between the second and third rows of the scanned image 100 as oriented in FIG. 1).

While the scanned image 100 is illustrated in FIG. 1 as including a non-distorted area 106 as well as a distorted area 108, examples of the disclosure are not so limited. For example, in some instances, there may not be any print job and/or scanned image defects introduced so that the entirety of the scanned image 100 is a non-distorted area, and an electronic device may detect fiducial marks 102, locate, based on the fiducial marks 102, respective target objects 104, and process the target objects 104 accordingly. However, even when there are instances of a distorted area, an electronic device can still detect fiducial marks 102, locate, based on the fiducial marks 102, respective target objects 104, and process the target objects 104 even if the fiducial marks 102 and the corresponding respective target objects 104 are located in non-distorted areas, distorted areas, and/or combinations thereof, as is further described herein.

An electronic device can detect a fiducial mark 102 of the scanned image 100. For example, the electronic device may scan the scanned image 100 to locate fiducial marks 102. As illustrated in FIG. 1, the electronic device can locate fiducial marks 102-1, 102-2, 102-4, and 102-N located in the non-distorted area 106 as well as locate fiducial mark 102-3 located in the distorted area 108.

Once the electronic device has detected the fiducial marks 102, the electronic device can locate a corresponding target object on the scanned image 100 associated with each fiducial mark 102. For example, the electronic device can locate target object 104-1 based on the fiducial mark 102-1, target object 104-2 based on the fiducial mark 102-2, target object 104-3 based on the fiducial mark 102-3, target object 104-4 based on the fiducial mark 102-4, and target object 104-N based on the fiducial mark 102-N. The electronic device can utilize information included in the fiducial marks (e.g., search instructions) to locate the corresponding target objects, as is further described in connection with FIGS. 2A-2C.

The electronic device can process the target object. For example, the electronic device can determine whether the target objects 104 include markings. For instance, once located, the electronic device can determine whether target object 104-1 includes a marking (yes), target object 104-2 includes a marking (no), target object 104-3 includes a marking (yes), target object 104-4 includes a marking (no), and whether target object 104-N includes a marking (no).

In order to check whether all of the target objects 104 have been processed, the electronic device can compare an amount of target objects 104 processed with a predetermined amount of target objects 104. As illustrated in FIG. 1, there can be an N amount of target objects 104. That is, the predetermined amount of target objects 104 can be N. For instance, the predetermined amount of target objects may be 75. In some examples, the electronic device may determine the predetermined amount of target objects 104 by scanning a master fiducial (e.g., a master QR code) including the predetermined amount of target objects 104 on the scanned image 100. In some examples, the predetermined amount of target objects 104 may be a user defined input to the electronic device.

The electronic device can compare the amount of target objects 104 processed with the predetermined amount of target objects 104. In some examples, the electronic device can determine the amount of target objects 104 processed is 75 and the predetermined amount of target objects 104 is 75; accordingly, when the electronic device compares the amount of target objects 104 processed with the predetermined amount of target objects 104, the electronic device can determine that all of the target objects 104 were successfully processed.

However, in some examples, the electronic device can determine the amount of target objects 104 processed is 74 and the predetermined amount of target objects 104 is 75; accordingly, when the electronic device compares the amount of target objects 104 processed with the predetermined amount of target objects 104, the electronic device can determine that not all of the target objects 104 were successfully processed. Accordingly, the electronic device can generate an alert in response to the amount of target objects 104 processed being different from the predetermined amount of target objects 104. Such an alert may be displayed (e.g., via a user interface of the electronic device, via a light source of the electronic device such as a light emitting diode (LED), etc.), transmitted to an external device (e.g., another computing device, a mobile device, etc.), and/or may be an audible alert emitted via an audio output device (e.g., a speaker). In such an instance, a user may be alerted that the scanned image 100 was not successfully processed and can cause the scanned image 100 to be re-scanned, reviewed manually, etc.

The electronic device can further determine an amount of unique fiducial marks 102 detected, and as a result, an amount of unique target objects 104 processed. As mentioned above, each of the fiducial marks 102 (e.g., each of the QR codes) can be unique from each other (e.g., each fiducial mark 102 is different from every other fiducial mark 102). Accordingly, in some examples, the electronic device can determine the amount of unique fiducial marks 102 detected is 75 and compare with the predetermined amount of target objects (e.g., 75). As such, since the predetermined amount of target objects is 75, the electronic device can have verified that each target object 104 was uniquely counted (and that one or multiple were not “double” counted).

However, in some examples, the electronic device can determine the amount of unique fiducial marks 102 detected is 74 and compare the amount of unique fiducial marks 102 detected with the predetermined amount of target objects (e.g., 75). Since the amount of unique fiducial marks 102 detected is not 75, the electronic device can generate an alert in response to the amount of unique fiducial marks detected not matching the predetermined amount of target objects. Such an example may occur if one of the target objects 104 was “double” counted (e.g., target object 104-3 or 104-1 are counted twice). However, the alert can serve to notify a user that the scanned image 100 was not successfully processed and can cause the scanned image 100 to be re-scanned, reviewed manually, etc. Accordingly, such an approach can prevent erroneous processing of the scanned image 100.

FIG. 2A is an example of a fiducial mark 202-1 located proximate with a target object 204-1 in a non-distorted area consistent with the disclosure. The fiducial mark 202-1 and the target object 204-1 can be located on a portion of the scanned image 200.

The fiducial mark 202-1 can be located proximate with the target object 204-1. Such a proximate location of the fiducial mark 202-1 relative to the target object 204-1 can be utilized to minimize the effect of any distortion that may occur on the scanned image 200.

As previously described in connection with FIG. 1, an electronic device can scan the scanned image 200 to locate the fiducial mark 202-1. The fiducial mark 202-1 can be uniquely associated with target object 204-1 and can provide search instructions to locate the target object 204-1 when scanned. For example, the QR code can include encoded information that can allow the electronic device to locate the target object 204-1 after scanning the fiducial mark 202-1.

The search instructions can include a coordinate system 210-1. As used herein, the term “coordinate system” refers to a system that uses one or multiple predefined numbers to uniquely determine a position of a point. The coordinate system 210-1 can be defined relative to the positioning/orientation of the fiducial mark 202-1. For example, the coordinate system 210-1 can define direction “X” which can define a horizontal direction (e.g., as oriented in FIG. 2A), where “right” as oriented in FIG. 2A is in a positive “X” direction and “left” as oriented in FIG. 2A is in a negative “X” direction. Additionally, the coordinate system 210-1 can define direction “Y” which can define a vertical direction (e.g., as oriented in FIG. 2A), where “up” as oriented in FIG. 2A is in a positive “Y” direction and “down” as oriented in FIG. 2A is in a negative “Y” direction. Further, the coordinate system 210-1 can define a distance between coordinates such that each coordinate can be spaced apart one millimeter (mm). The electronic device can locate the target object 204-1 according to the directions and coordinate spacing predefined by the coordinate system 210-1, as is further described herein.

As illustrated in FIG. 2A, the coordinate system 210-1 is shown outside of the fiducial mark 202-1. However, as mentioned above, the search instructions, including the coordinate system 210-1, are encoded into the fiducial mark 202-1. As such, the coordinate system 210-1 is not visible on the scanned image 200, but rather is merely shown in FIG. 2A for illustrative purposes.

In addition to the coordinate system 210-1, the search instructions can include a search direction, a search distance, and/or a search area. As used herein, the term “search direction” refers to a predefined instruction to locate an area on a line extending from a particular point. As used herein, the term “search distance” refers to a predefined instruction to locate an area extending from a particular point across a particular amount of space. As used herein, the term “search area” refers to a predefined instruction to locate a zone located within a particular extent of space. For example, the fiducial mark 202-1 can include a search distance and a search direction (e.g., from the fiducial mark 202-1, proceed 5 mm in the positive “X” direction). Additionally, the fiducial mark 202-1 can include a search area (e.g., once moved 5 mm in the positive “X” direction, search an area 3 mm in radius from that point for the target object 204-1). Accordingly, the electronic device can locate the target object 204-1 by detecting the fiducial mark 202-1 and locating the target object 204-1 in a search area defined by a search distance and a search direction.

In some examples, the scanned image 200 can include a lead line 212-1. The lead line 212-1 can be a line extending between the fiducial mark 202-1 and to the target object 204-1. In some examples, the search instruction may include a search direction defined by the lead line 212-1 (e.g., proceed a distance along the lead line 212-1 until the lead line 212-1 intersects another line). The additional (e.g., another) line (or lines) may be, for instance, a reticle located in the target object 204-1. The reticle can include a pattern of lines or markings utilized to locate the target object 204-1 by the electronic device. Such a reticle may be visible to a user, or not visible (e.g., printed via UV or magnetic ink).

FIG. 2B is an example of a fiducial mark located proximate with a target object in a distorted area consistent with the disclosure. The fiducial mark 202-3 and the target object 204-3 can be located on a portion of the scanned image 200.

As previously described in connection with FIG. 1, an electronic device can scan the scanned image 200 to locate the fiducial mark 202-3. The fiducial mark 202-3 can be uniquely associated with target object 204-3 and can provide search instructions to locate the target object 204-3 when scanned. Additionally, as illustrated in FIG. 2B, the fiducial mark 202-3 is located in a distorted area of the scanned image 200. However, the electronic device is still able to locate the target object 204-3, as the distorted area does not affect the location process of the electronic device, as is further described herein.

Similar to the approach previously described in FIG. 2A, the search instructions of the fiducial mark 202-3 define a coordinate system 210-3. As mentioned above, the coordinate system 210-3 can be defined relative to the orientation of the fiducial mark 202-3. Accordingly, even though the fiducial mark 202-3 is in a distorted area of the scanned image 200 and thus its orientation differs from the fiducial mark 202-1 located in the non-distorted area, the coordinate system 210-3 can compensate for such an orientation change. For example, the distorted area may be a skew of 4°. Accordingly, the coordinate system 210-3 can define direction “X” and direction “Y” similar to that of coordinate system 210-1, but with a 4° skew, since the coordinate system 210-3 is defined relative to the orientation of the fiducial mark 202-3. Further, the coordinate system 210-3 can define the distance between coordinates such that each coordinate can be spaced apart 1 mm. The electronic device can locate the target object 204-3 according to the directions and coordinate spacing predefined by the coordinate system 210-3, as is further described herein.

For example, the fiducial mark 202-3 can include a search distance and a search direction (e.g., from the fiducial mark 202-3, proceed 5 mm in the positive “X” direction). Additionally, the fiducial mark 202-3 can include a search area (e.g., once moved 5 mm in the positive “X” direction, search an area 3 mm in radius from that point for the target object 204-3). Accordingly, the electronic device can locate the target object 204-3 by detecting the fiducial mark 202-3 and locating the target object 204-3 in a search area defined by a search distance and a search direction. As such, while the search instructions of fiducial mark 202-3 may be similar to that of fiducial mark 202-1, because the coordinate system 210-3 is defined relative to the orientation of the fiducial mark 202-3 (e.g., which is skewed by 4°), the search instructions of fiducial mark 202-3 can also be skewed by 4°.

As illustrated in FIG. 2B, the coordinate system 210-3 is shown outside of the fiducial mark 202-3. However, as mentioned above, the search instructions, including the coordinate system 210-3, are encoded into the fiducial mark 202-3. As such, the coordinate system 210-3 is not visible on the scanned image 200, but rather is merely shown in FIG. 2B for illustrative purposes.

Therefore, even if a print defect and/or a scan defect is present in the scanned image 200 causing a fiducial mark 202 and a corresponding target object 204 to be located in a distorted area, the search instructions included in a particular fiducial mark 202 can naturally compensate for the distortion because the search instructions, including the coordinate system within the fiducial marks 202, are defined relative to an orientation of the fiducial marks 202. Accordingly, the electronic device can locate target objects 204 based on corresponding fiducial marks 202 even in instances where print defects and/or scan defects are present in the scanned Image 200.

FIG. 2C is an example of a fiducial mark 202-4 located around a target object 204-4 consistent with the disclosure. The fiducial mark 202-4 and the target object 204-4 can be located on a portion of the scanned image 200.

As illustrated in FIG. 2C, in some examples, the fiducial mark 202-4 can be located around the target object 204-4. Locating the fiducial mark 202-4 around the target object 204-4 can allow for simple search instructions.

For example, the fiducial mark 202-4 can be uniquely associated with target object 204-4 and can provide search instructions to locate the target object 204-4 when scanned. The coordinate system 210-4 can define direction “X” and direction “Y” similar to that of coordinate system 210-1. Further, the coordinate system 210-4 can define the distance between coordinates such that each coordinate can be spaced apart 1 mm. The electronic device can locate the target object 204-4 according to the directions and coordinate spacing predefined by the coordinate system 210-4, as is further described herein.

For example, the fiducial mark 202-4 can include search instructions including a search distance, a search direction, and/or a search area. For instance, the search instructions can instruct the electronic device to proceed to a middle of the fiducial mark 202-4 according to the directions and coordinate spacing predefined by the coordinate system 210-4.

As illustrated in FIG. 2C, the coordinate system 210-4 is shown outside of the fiducial mark 202-4. However, as mentioned above, the search instructions, including the coordinate system 210-4, are encoded into the fiducial mark 202-4. As such, the coordinate system 210-4 is not visible on the scanned image 200, but rather is merely shown in FIG. 2C for illustrative purposes.

Accordingly, the fiducial mark 202-4 being located around the target object 204-4 can allow for simple search instructions. Further, in instances of distortion on the scanned image 200, the fiducial mark 202-2 being located around the target object 204-4 can reduce the effect of such distortion causing any issues for the electronic device detecting the fiducial mark 202-4 and locating the target object 204-4.

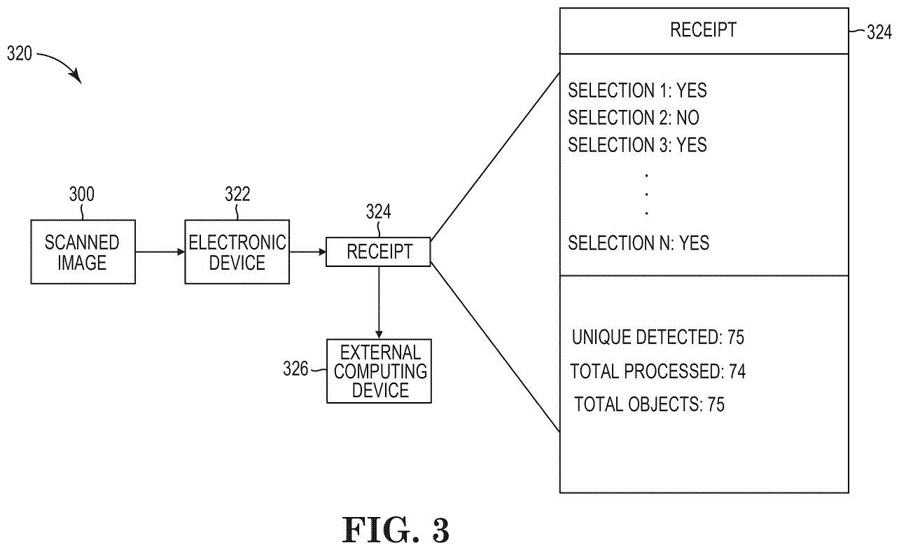

FIG. 3 is an example of a system 320 to locate target objects based on fiducial marks consistent with the disclosure. The system 320 can include a scanned image 300, an electronic device 322, a receipt 324, and an external computing device 326.

As previously described in connection with FIG. 1, the scanned image 300 may be received by an electronic device 322. The electronic device 322 can detect fiducial marks on the scanned image 300 and locate, based on search instructions encoded in the fiducial marks, respective corresponding target objects associated with the fiducial marks. Further, the electronic device 322 can process the target objects by determining whether such target objects included markings or not.

The electronic device 322 can generate a receipt 324 based on the target objects processed. As used herein, the term “receipt” refers to a recorded acknowledgment of an action. In some examples, the electronic device 322 can determine which of the processed target objects had markings and detail such results in the generated receipt 324. For instance, as illustrated in FIG. 3, the receipt 324 can detail the markings per processed target object (e.g., SELECTION 1 had a marking and as such is indicated as “YES”, SELECTION 2 did not have a marking and as such is indicated as “NO”, SELECTION 3 had a marking and as such is indicated as “YES”, SELECTION N had a marking and as such is indicated as “YES”, etc.)

The electronic device 322 can determine an amount of unique fiducial marks detected. For instance, the receipt 324 can illustrate that the UNIQUE DETECTED fiducial marks include 75 uniquely detected fiducial marks. The electronic device 322 can compare the amount of uniquely detected fiducial marks against the predetermined amount of target objects. As indicated by the receipt 324, the electronic device 322 has detected each of the unique fiducial marks on the scanned image.

Additionally, in some examples the electronic device 322 can compare an amount of target objects processed with a predetermined amount of target objects. For instance, as illustrated in FIG. 3, the receipt 324 can illustrate that the TOTAL PROCESSED target objects is 74, but the TOTAL OBJECTS is 75. Such a discrepancy can cause the electronic device 322 to generate an alert in response to the amount of target objects processed being different from the predetermined amount of target objects, as previously described in connection with FIG. 1. Further, such a discrepancy can indicate to a user that one of the target objects was not processed correctly, and can allow the user to cause the scanned image 300 to be re-scanned, reviewed manually, etc.

The electronic device 322 can, in some examples, transmit the receipt 324 to an external computing device 326. In some examples, the external computing device 326 can be a computing device at a testing center, a surveying location, etc. In some examples, the external computing device 326 can be a mobile device. A user may review the receipt 324 using the external computing device 326, among other actions.

Locating target objects based on fiducial marks according to the disclosure can allow for accurate detection of target objects. Such detection can occur on a normal scanned image, and/or in instances where an image defect is present in the scanned image. A 1:1 fiducial mark/target object ratio can be utilized such that a unique set of fiducial marks can each correspond to a particular respective target object such that each target object can be located based on location of an associated fiducial mark. If an amount of target objects processed is not the same as a predetermined amount of target objects to be processed, an alert can be generated reducing chances of processing errors. Accordingly, such an approach can allow for a more accurate analysis of the digital image as compared with previous approaches.

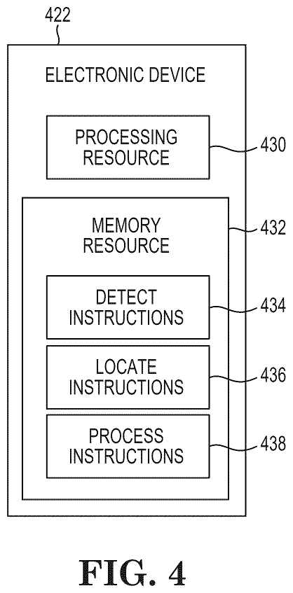

FIG. 4 is an example of an electronic device 422 to locate target objects based on fiducial marks. As described herein, the electronic device 422 may perform functions related to locating target objects based on fiducial marks. Although not illustrated in FIG. 4, the electronic device 422 may include a processor and a non-transitory machine-readable storage medium. Although the following descriptions refer to a single processor and a single machine-readable storage medium, the descriptions may also apply to a system with multiple processors and multiple machine-readable storage mediums. In such examples, the electronic device 422 may be distributed across multiple machine-readable storage mediums and across multiple processors. Put another way, the instructions executed by the electronic device 422 may be stored across multiple machine-readable storage mediums and executed across multiple processors, such as in a distributed or virtual computing environment.

Processing resource 430 may be a central processing unit (CPU), a semiconductor-based microprocessor, and/or other hardware devices suitable for retrieval and execution of machine-readable instructions 434, 436, 438 stored in a memory resource 432. Processing resource 430 may fetch, decode, and execute instructions 434, 436, 438. In another implementation, processing resource 430 may include a plurality of electronic circuits that include electronic components for performing the functionality of instructions 434, 436, 438.

Memory resource 432 may be any electronic, magnetic, optical, or other physical storage device that stores executable instructions 434, 436, 438, and/or data. Thus, memory resource 432 may be, for example, Random Access Memory (RAM), an Electrically-Erasable Programmable Read-Only Memory (EEPROM), a storage drive, an optical disc, and the like. Memory resource 432 may be disposed within electronic device 422, as shown in FIG. 4. Additionally, memory resource 432 may be a portable, external or remote storage medium, for example, that causes electronic device 422 to download the instructions 434, 438, 438 from the portable/external/remote storage medium.

The electronic device 422 may include instructions 434 stored in the memory resource 432 and executable by the processing resource 430 to detect a fiducial mark of a plurality of fiducial marks on a scanned image. The scanned image can include a plurality of fiducial marks and a plurality of target objects. Each fiducial mark of the plurality of fiducial marks can be uniquely associated with a respective target object of the plurality of target objects.

The electronic device 422 may include instructions 436 stored in the memory resource 432 and executable by the processing resource 430 to locate, based on the fiducial mark, a target object on the scanned image associated with the fiducial mark. The electronic device 422 can locate the target object utilizing search instructions encoded in the fiducial mark. The search instructions can include a coordinate system, as well as a search direction, a search distance, and/or a search area.

The electronic device 422 may include instructions 438 stored in the memory resource 432 and executable by the processing resource 430 to process the target object. The electronic device 422 can process the target object by determining whether the target object includes a marking.

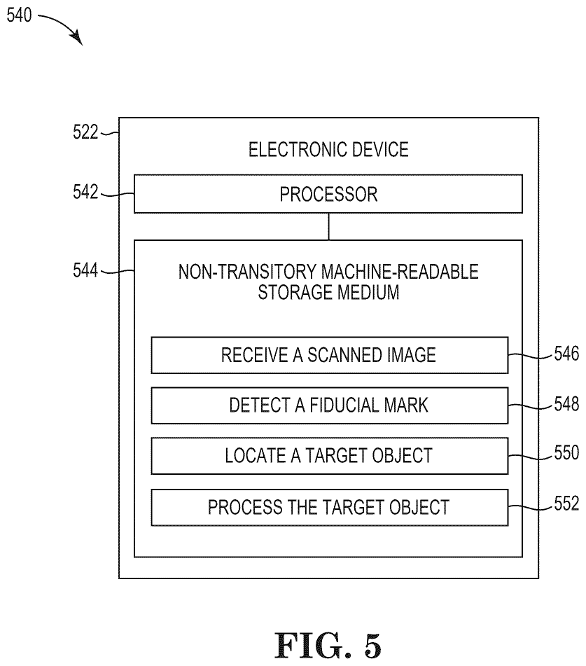

FIG. 5 is a block diagram of an example system 540 to locate target objects based on fiducial marks consistent with the disclosure. In the example of FIG. 5, system 540 includes an electronic device 522 including a processor 542 and a non-transitory machine-readable storage medium 544. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 542 may be a central processing unit (CPU), microprocessor, and/or other hardware device suitable for retrieval and execution of instructions stored in the non-transitory machine-readable storage medium 544. In the particular example shown in FIG. 5, processor 542 may receive, determine, and send instructions 546, 548, 550, 552. In another implementation, processor 542 may include an electronic circuit comprising a number of electronic components for performing the operations of the instructions in the non-transitory machine-readable storage medium 544. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 544 may be any electronic, magnetic, optical, or other physical storage device that stores executable instructions. Thus, non-transitory machine-readable storage medium 544 may be, for example, Random Access Memory (RAM), an Electrically-Erasable Programmable Read-Only Memory (EEPROM), a storage drive, an optical disc, and the like. The executable instructions may be “installed” on the system 540 illustrated in FIG. 5. Non-transitory machine-readable storage medium 544 may be a portable, external or remote storage medium, for example, that allows the system 540 to download the instructions from the portable/external/remote storage medium. In this situation, the executable instructions may be part of an “installation package”.

Receive instructions 546, when executed by a processor such as processor 542, may cause system 540 to receive a scanned image. The scanned image can include a plurality of fiducial marks and a plurality of target objects, where each fiducial mark of the plurality of fiducial marks is uniquely associated with a respective target object of the plurality of target objects.

Detect instructions 548, when executed by a processor such as processor 542, may cause system 540 to detect a fiducial mark of the plurality of fiducial marks. Each fiducial mark of the plurality of fiducial marks can be uniquely associated with a respective target object of the plurality of target objects.

Locate instructions 550, when executed by a processor such as processor 542, may cause system 540 to locate a target object on the scanned image associated with the fiducial mark. The system 540 can locate the target object utilizing search instructions encoded in the fiducial mark. The search instructions can include a coordinate system, as well as a search direction, a search distance, and/or a search area.

Process instructions 552, when executed by a processor such as processor 542, may cause system 540 to process the target object. The electronic device 522 can process the target object by determining whether the target object includes a marking.

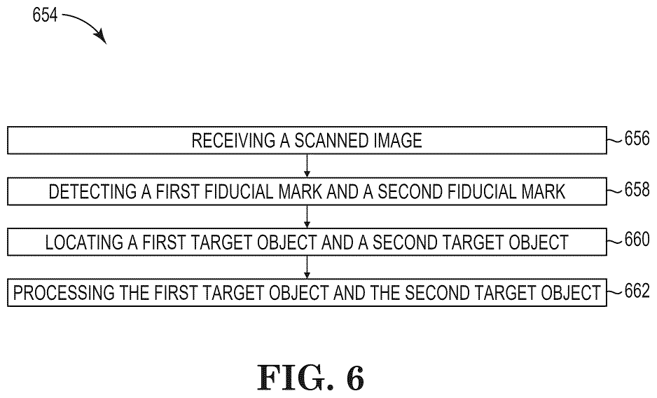

FIG. 6 is an example of a method 654 to locate target objects based on fiducial marks consistent with the disclosure. The method 654 can be performed by an electronic device (e.g., electronic device 322, 422, and 522, previously described in connection with FIGS. 3, 4, and 5, respectively).

At 656, the method 654 includes receiving a scanned image. The scanned image can include a plurality of fiducial marks and a plurality of target objects, where each fiducial mark of the plurality of fiducial marks is uniquely associated with a respective target object of the plurality of target objects. In some examples, the scanned image can include a distorted area and a non-distorted area.

At 658, the method 654 includes detecting a first fiducial mark and a second fiducial mark. The first fiducial mark can be located in the non-distorted area and the second fiducial mark can be located in the distorted area.

At 660, the method 654 includes locating a first target object and a second target object. The first target object can be located via a search instruction encoded in the first fiducial mark. The second target object can be located via a search instruction encoded in the second fiducial mark.

At 662, the method 654 includes processing the first target object and the second target object. The first target object can be processed by determining whether the first target object includes a marking. The second target object can be processed by determining whether the second target object includes a marking.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An electronic device, comprising:
a processing resource; and
a non-transitory memory resource storing machine-readable instructions to cause the processing resource to:
detect a fiducial mark of a plurality of fiducial marks on a scanned image, wherein:
the scanned image includes the plurality of fiducial marks and a plurality of target objects; and
each fiducial mark of the plurality of fiducial marks is uniquely associated with a respective target object of the plurality of target objects;
locate, based on the fiducial mark, a target object on the scanned image associated with the fiducial mark; and
process the target object.

2. The electronic device of claim 1, wherein:
the scanned image includes a distorted area; and
at least one of the fiducial mark and the target object are located in the distorted area.

3. The electronic device of claim 1, wherein the plurality of fiducial marks each define a search instruction to locate a respective target object of the plurality of target objects.

4. The electronic device of claim 3, wherein each search instruction of each of the plurality of fiducial marks includes a coordinate system and at least one of:
a search direction;
a search distance; and
a search area.

5. The electronic device of claim 1, including instructions to cause the processing resource to:
compare an amount of target objects processed with a predetermined amount of target objects; and
generate an alert in response to the amount of target objects processed being different from the predetermined amount of target objects.

6. The electronic device of claim 1, wherein the fiducial mark is located proximate to the target object.

7. The electronic device of claim 1, wherein the fiducial mark is located around the target object.

8. The electronic device of claim 1, wherein the fiducial mark is a quick response (QR) code.

9. A non-transitory machine-readable storage medium including instructions that when executed cause a processor of an electronic device to:
receive a scanned image including a plurality of fiducial marks and a plurality of target objects, wherein each fiducial mark of the plurality of fiducial marks is uniquely associated with a respective target object of the plurality of target objects;
detect a fiducial mark of the plurality of fiducial marks;
locate, based on a search instruction encoded in the fiducial mark, a target object on the scanned image associated with the fiducial mark; and
process the target object.

10. The medium of claim 9, including instructions to cause the processor to locate the target object by detecting the fiducial mark associated with the target object in a search area defined by the search instruction.

11. The medium of claim 9, including instructions to cause the processor to process the target object by determining whether the target object includes a marking.

12. The medium of claim 9, wherein each fiducial mark of the plurality of fiducial marks is unique from other fiducial marks of the plurality of fiducial marks.

13. A method, comprising:
receiving, by an electronic device, a scanned image including a plurality of fiducial marks and a plurality of target objects, wherein:
the scanned image includes a distorted area and a non-distorted area; and
each fiducial mark of the plurality of fiducial marks is uniquely associated with a respective target object of the plurality of target objects;
detecting, by the electronic device, a first fiducial mark of the plurality of fiducial marks that is located in the non-distorted area and a second fiducial mark of the plurality of fiducial marks located in the distorted area;
locating, by the electronic device:
a first target object of the plurality of target objects that is uniquely associated with the first fiducial mark via a search instruction encoded in the first fiducial mark; and
a second target object of the plurality of target objects that is uniquely associated with the second fiducial mark via a search instruction encoded in the second fiducial mark; and
processing, by the electronic device, the first target object and the second target object.

14. The method of claim 13, wherein the method includes generating, by the electronic device, a receipt based on target objects processed.

15. The method of claim 14, wherein the method includes at least one of:
transmitting, by the electronic device, the receipt to an external computing device; and
printing, by the electronic device, the receipt via a print job.
